(19) United States
(12) Patent Application Publication
(10) Pub. No.: US 2013/0080734 A1
(43) Pub. Date: Mar. 28, 2013

(54) ADDRESS TRANSLATION UNIT, METHOD OF CONTROLLING ADDRESS TRANSLATION UNIT AND PROCESSOR

(71) Applicants: Yasuharu Sato, Kawasaki (JP); Iwao Yamazaki, Atami (JP)

(72) Inventors: Yasuharu Sato, Kawasaki (JP); Iwao Yamazaki, Atami (JP)

(73) Assignee: FUJITSU LIMITED, Kawasaki-shi (JP)

(21) Appl. No.: 13/562,412

(22) Filed: Jul. 31, 2012

(30) Foreign Application Priority Data
Sep. 26, 2011 (JP) 2011-209756

(51) Int. Cl. G06F 12/10

(52) U.S. Cl. 711/207; 711/E12.061

(57) ABSTRACT

Disclosed herein is a micro TLB which includes a CAM section having a plurality of CAM circuits, each stores address information which represents correlation between a virtual address and a physical address; and a write control section which directs writing of the address information into each CAM circuit pointed by a write pointer, when a new address information is requested to be stored, wherein the micro TLB being configured to increment the write pointer, if the address information stored in each CAM circuit pointed by the write pointer has been used for address translation, so as to hold a recently-used address information while preventing the CAM circuit, having indication of use of the address information, from being overwritten with the new address information.

### CROSS-REFERENCE TO RELATED APPLICATION

This application is based upon and claims the benefit of priority of the prior Japanese Patent Application No. 2011-209756, filed on Sep. 26, 2011, the entire contents of which are incorporated herein by reference.

### FIELD

The embodiments discussed herein are related to an address translation unit, a method of controlling an address translation unit, and a processor.

### BACKGROUND

When a plurality of processes run on a computer, address spaces in which the individual processes run need be independent, so as to allow the processes to be executed even if size of the address spaces used by the processes exceeds an address space practically available on an actual physical memory. A virtual memory is provided for this purpose. In the virtual memory, any access by a processor to a main memory or the like is made by translating a virtual address (VA) output by the processor into a physical address (PA).

The access may, however, take a lot of time if the translation from the virtual address to the physical address takes place for every access, referring to an address translation table stored in the main memory. Aimed at increasing rate of translation to the physical address, there has been known a technique of providing a translation lookaside buffer which holds (caches) a part of information of the address translation table used for translation from the virtual address to the physical address.

In addition, there has been an increasing trend of adopting a two-level TLB structure, similarly to cache memory, configured by a micro TLB rapidly accessible but with a small capacity (only a small number of entries affordable), and a main TLB slowly accessible but with a large capacity. In this configuration, the processor accesses the memory or the like, referring to information of the address translation tables in the micro TLB, the main TLB, and the main memory, successively in this order, for address translation.

FIG. 7 is a drawing illustrating an exemplary configuration of the micro TLB based on the FIFO (First In First Out) control scheme. In the micro TLB illustrated in FIG. 7, a new entry is registered by writing the new entry (address information which represents correlation between the virtual address and the physical address) into a storage unit pointed by a pointer (write pointer signal) based on the FIFO scheme. In FIG. 7, reference numeral 101 denotes a CAM (Content Addressable Memory) section, and 102 denotes a write control section.

The CAM section 101 has a plurality of CAM circuits 103-i, where suffix i represents a natural number (i=1, 2, 3, . . . , N, the same will apply hereinbelow). Each of the CAM circuits 103-i stores address information of one entry, or, one virtual address and one physical address corresponded thereto.

When a write enable signal WEN-i becomes active, the CAM circuit 103-i receives, so as to be written and created in a latch circuit contained therein, an address information being supplied (a virtual address WVA and a physical address WPA to be created as a new entry). If the already-created virtual address matches a virtual address AVA specified by an access request relevant to data or the like, the CAM circuit 103-i outputs a hit signal Hit-i, and also outputs the already-created physical address as a physical address PAD-i.

The write control section 102 has write control circuits 104-i, a FIFO counter latch circuit 105, a FIFO counter increment circuit 106, and a write selection circuit 107. When both of a received write pointer signal WPS-i and a write signal WS are active, each write control circuit 104-i activates the write enable signal WEN-i to be output.

Upon reception of the write signal WS, the FIFO counter latch circuit 105 latches, and then outputs, an output signal of the FIFO counter increment circuit 106. The FIFO counter increment circuit 106 increments a count value output from the FIFO counter latch circuit 105 by one, and outputs the incremented count value.

The write selection circuit 107 decodes the count value output from the FIFO counter latch circuit 105, and activates any one (write pointer signal WPS-i) of the write pointer signals WPS-1 to WPS-N. The activated write pointer signal WPS-i corresponds to a write pointer which points a storage unit (CAM circuit 103-i) into which information will be written next.

In the micro TLB illustrated in FIG. 7, a new entry (address information) will be written as described below. Upon reception of a write instruction of entry (activated write signal WS), each write control circuit 104-i activates the write enable signal WEN-i to be output to each CAM circuit 103-i pointed by the write pointer (activated write pointer signal WPS-i). When the write enable signal WEN-i becomes active, the target CAM circuit 103-i receives, so as to be written and created in the latch circuit contained therein, address information having a virtual address WVA and a physical address WPA to be created as a new entry.

In parallel with the creation of the address information, the FIFO counter latch circuit 105 latches the count value which is an incremented pointer information, for the preparation of writing of address information. In this way, upon occurrence of the next writing, the address information will be written in the CAM circuit 103-i positioned next to the CAM circuit 103-i having the address information previously written therein. Thereafter, the write pointer will be incremented every time the writing occurs, and the address information will be written in the CAM circuits 103-i according to a predetermined order.

There has been proposed a method of replacing the individual pages in the virtual memory, characterized by setting a priority to every page depending on volume of processing, and by determining a page to be processed based on whether the page has been accessed within a certain time determined by the priority.

There has also been proposed a TLB, in which every entry has a bit indicating that whether the entry is valid or not, and a bit indicating the entry has been used or not. If there is no invalid entry, the TLB allows replacement of the entries having no indication of use. On the other hand, if all entries are valid and have indication of use, the TLB alters the bit values so as to indicate as if all entries other than those recently accessed are not in use, to thereby implement a pseudo LRU (least-recently-used) scheme.

[Patent Document 1] Japanese Laid-Open Patent Publication No. 07-152652

[Patent Document 2] U.S. Pat. No. 5,802,568

In the micro TLB based on the FIFO control scheme as illustrated in FIG. 7, writing of the entries takes place by sequentially rewriting the entries, irrespective of frequency of read-out of the entries. Accordingly, even a frequently-used entry will be erased by overwriting of a new entry, if the write pointer points the storage unit (CAM circuit) having the entry created therein. Mishitting (entry is not hit) will therefore increase when the micro TLB is referred to, and thereby the performance will degrade. On the other hand, the pseudo LRU scheme needs a large size of circuit relevant to the LRU control, or a large area for mounting, due to complexity of the control.

### SUMMARY

According to an aspect of the embodiment, an address translation unit includes a storage unit which includes a plurality of entries, each entry stores, in a correlated manner, address information which represents correlation between virtual address and physical address, and use information which indicates whether the address information has been used for address translation or not; a pointer unit which holds a pointer value which points each entry into which a new address information is stored; an increment unit which increments the pointer value held by the pointer unit; a control unit which refers to an entry pointed by the pointer value held by the pointer unit, when the new address information is stored in the storage unit, and, if the use information of the referred entry indicates that the address information corresponded to each entry has been used for address translation, allows the increment unit to increment the pointer value, and allows storage of the new address information into an entry pointed by the incremented pointer value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing illustrating an exemplary configuration of an information processing device which includes a processor according to a present embodiment;

FIG. 2 is a drawing illustrating an exemplary configuration of a TLB unit according to the present embodiment;

FIG. 3 is a drawing illustrating an exemplary configuration of a micro TLB unit according to the present embodiment;

FIG. 4 is a drawing illustrating an exemplary configuration of a CAM circuit according to the present embodiment;

FIG. 5 is a drawing illustrating an exemplary configuration of a write control circuit according to a first embodiment;

FIG. 6 is a drawing illustrating an exemplary configuration of a write control circuit according to a second embodiment; and

FIG. 7 is a drawing illustrating an exemplary configuration of a micro TLB based on the FIFO control scheme.

### DESCRIPTION OF EMBODIMENTS

Embodiments of the present invention will be detailed below, referring to the attached drawings.

### First Embodiment

A first embodiment will be explained.

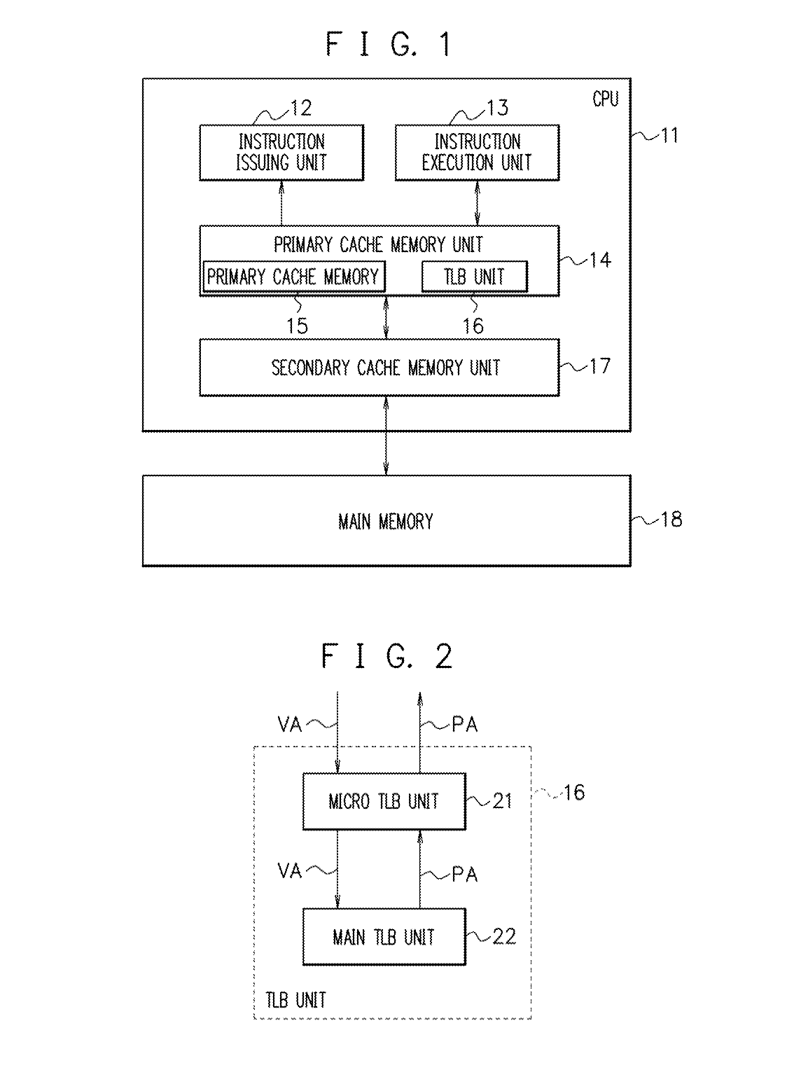

FIG. 1 is a drawing illustrating an exemplary configuration of an information processing device according to a present embodiment.

In FIG. 1, reference numeral 11 denotes a CPU (Central Processing Unit) as a processor, and reference numeral 18 denotes a main memory (main storage unit). The CPU 11 has an instruction issuing unit 12, an instruction execution unit 13, a primary cache memory unit 14 which includes a primary cache memory 15 and a TLB (Translation Lookaside Buffer) unit 16, and a secondary cache memory unit 17. The CPU 11 (the instruction issuing unit 12, the instruction execution unit 13, the primary cache memory unit 14, and the secondary cache memory unit 17) is typically configured on a single chip, and is connected to a main memory 18 through an unillustrated bus or the like.

The instruction issuing unit 12 and the instruction execution unit 13 take part in control of instruction flow and related calculation executed by the CPU 11. The instruction issuing unit 12 decodes an instruction code received from a storage device, and issues, based on the result, an instruction to be executed by the instruction execution unit 13. The instruction execution unit 13 executes the instruction issued by the instruction issuing unit 12. For example, the instruction execution unit 13 reads data from the storage device, calculates the data according to the instruction received from the instruction issuing unit 12, and outputs the result. The primary cache memory 15, the secondary cache memory unit 17, and the main memory 18 are memory devices which store codes and data and so forth to be read by the instruction issuing unit 12 and the instruction execution unit 13.

The primary cache memory 15 is rapidly responsible to requests issued from the instruction issuing unit 12 and the instruction execution unit 13. The secondary cache memory unit 17 stores information which are accessed relatively frequently, out of those (instruction code, data, etc.) not storable in the primary cache memory 15 due to their large size relative to the storage capacity. The information (instruction code, data, etc.) not storable in the secondary cache memory unit 17, due to their large size relative to the storage capacity, are stored in the main memory 18.

The main memory 18 stores an address translation table (address information which represents correlation between the virtual address and the physical address) used for translation from the virtual address to the physical address. The TLB unit 16 holds (caches) a part of information of the address translation table used for translation from the virtual address to the physical address, and translates the virtual addresses output from the instruction issuing unit 12 and the instruction execution unit 13 into the physical addresses.

When reading of data or the like is requested by the instruction issuing unit 12 and the instruction execution unit 13, the TLB unit 16 translates the virtual address into the physical address, and accesses the memory devices (primary cache memory 15, secondary cache memory unit 17, main memory 18) using the physical address. If correspondent data or the like is found in the primary cache memory 15, the data or the like is supplied from the primary cache memory 15 to the instruction issuing unit 12 and the instruction execution unit 13.

On the other hand, if the correspondent data or the like is not found in the primary cache memory 15, the secondary cache memory unit 17 is searched, and if found in the secondary cache memory unit 17, the data or the like is supplied from the secondary cache memory unit 17 through the primary cache memory 15 to the instruction issuing unit 12 and the instruction execution unit 13. If the data or the like is not found still also in the secondary cache memory unit 17, the data or the like is supplied from the main memory 18, through the secondary cache memory unit 17 and the primary cache memory 15, to the instruction issuing unit 12 and the instruction execution unit 13.

FIG. 2 is a drawing illustrating an exemplary configuration of the TLB unit 16. The TLB unit 16 of this embodiment adopts a two-level structure, similarly to the data cache memory, contributed by a micro TLB unit 21 and a main TLB unit 22.

The micro TLB unit 21 is a TLB rapidly accessible but with a small capacity (only a small number of entries affordable). Since the micro TLB unit 21 is required to be high-speed, so that it is configured typically by CAMs (Content Addressable Memories) having latch circuits, making use of a full-associative scheme as a method of making reference. On the other hand, the main TLB unit 22 is a TLB unit slower than the micro TLB unit 21 but has a larger capacity (a large number of entries affordable). The main TLB unit 22 typically adopts a set associative scheme as a method of making reference, and is configured by SRAMs (Static Random Access Memories) or the like.

When a request is issued from the instruction issuing unit 12 or the instruction execution unit 13, the TLB unit 16 searches through the address information using the virtual address VA specified in the request, and translates the virtual address VA into the physical address PA. First, the micro TLB unit 21 is searched through, and if the address information relevant to the specified virtual address VA is found, information of the physical address PA contained in the address information (physical address PA corresponded to the virtual address VA) is output as a translated physical address PA.

If information relevant to the specified virtual address VA was not found in the micro TLB unit 21, the virtual address VA is supplied to the main TLB unit 22, and the main TLB unit 22 is searched through using the supplied virtual address VA. If the address information relevant to the specified virtual address VA was found in the main TLB unit 22, information of the physical address PA contained in the address information is output to the micro TLB unit 21, and created therein. The micro TLB unit 21 is searched again, and information of the physical address corresponded to the specified virtual address VA is output from the micro TLB unit 21.

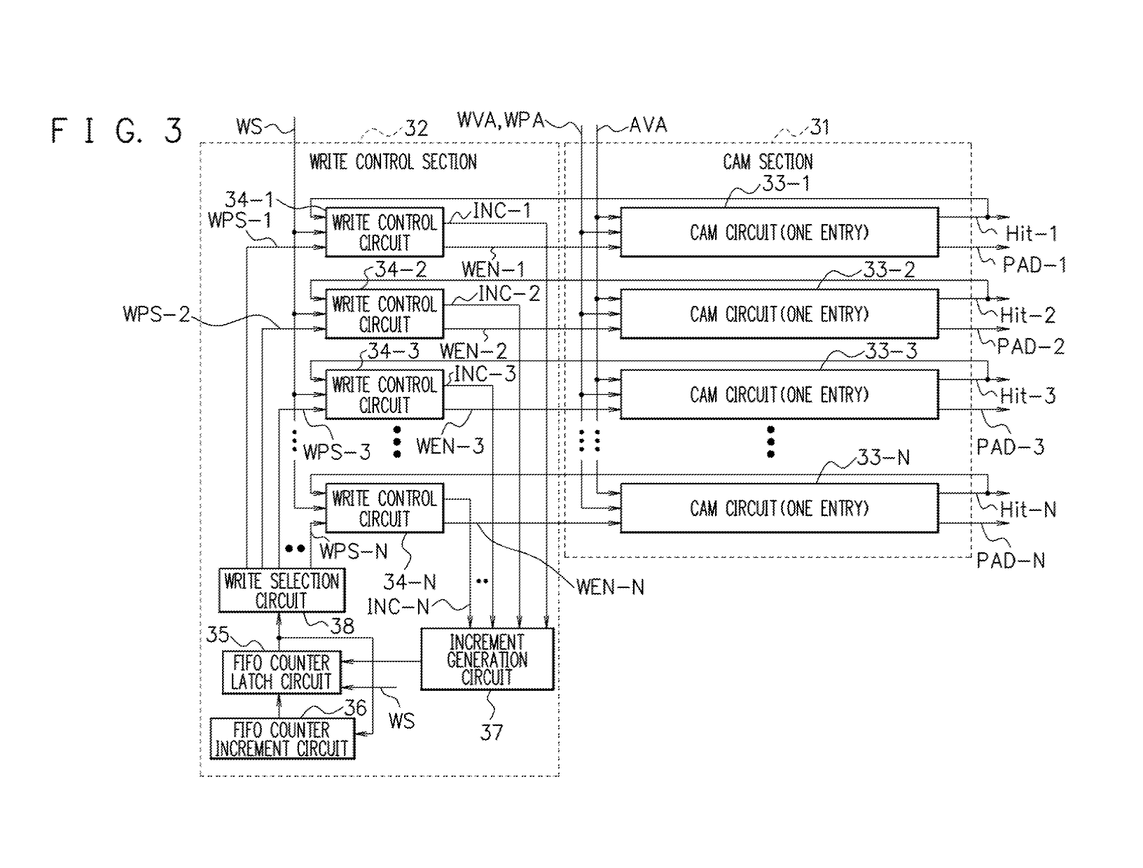

FIG. 3 is a drawing illustrating an exemplary configuration of the micro TLB unit 21. The micro TLB unit 21 illustrated in FIG. 3 adopts a write pointer based on the FIFO (First In First Out) control scheme. In the micro TLB unit 21 illustrated in FIG. 3, a new entry which represents correlation between the virtual address and the physical address is written and created in the storage unit (CAM circuit 33-i) pointed by the write pointer (write pointer signal). Upon completion of writing of the new entry into the storage unit pointed by the write pointer, the write pointer is incremented by one to point the storage unit to be written next. Note that, in the description below, suffix i represents a natural number (i=1, 2, 3, . . . , N).

As illustrated in FIG. 3, the micro TLB unit 21 has a CAM (Content Addressable Memory) section 31 and a write control section 32. The CAM section 31 has a plurality of CAM circuits 33-i, each of which stores address information of one entry, or, one virtual address and one physical address corresponded thereto.

Each CAM circuit 33-i receives the virtual address WVA and the physical address WPA which are created as an entry as a result of writing, and also receives the virtual address AVA specified in the access request relevant to data or the like. The CAM circuit 33-i also receives the write enable signal WEN-i. For example, the virtual address WVA and the physical address WPA are supplied from the main TLB 21, and the virtual address AVA is supplied from the instruction issuing unit 12 and the instruction execution unit 13. The CAM circuit 33-i outputs the hit signal Hit-i which indicates whether the entry was hit (whether the entry has been used for translation of the virtual address) or not, and outputs the physical address PAD-i.

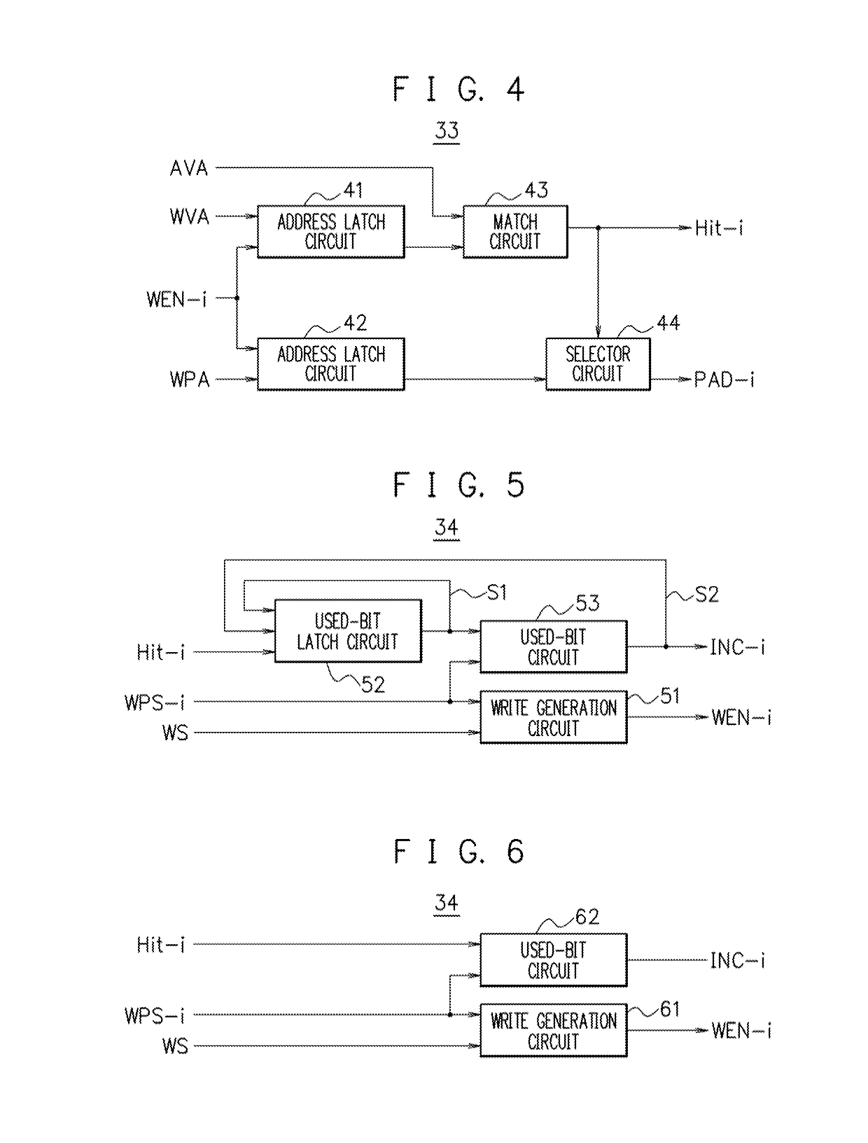

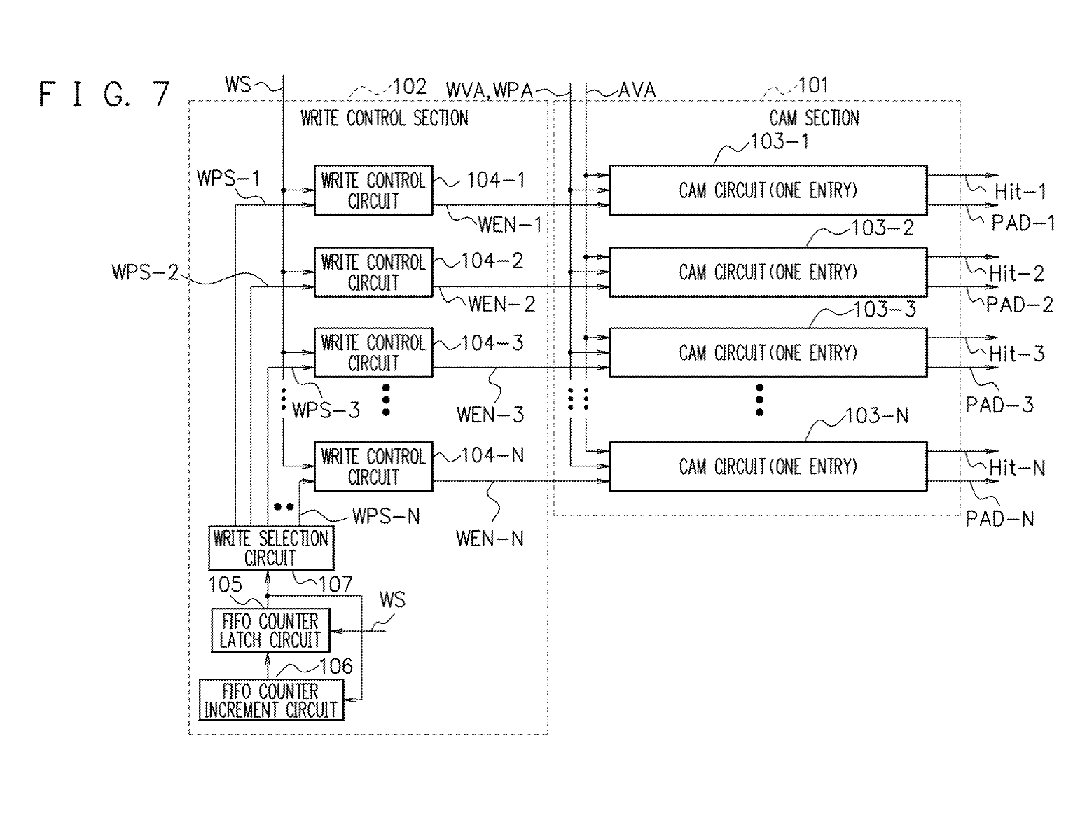

An exemplary configuration of the CAM circuit 33-i is illustrated in FIG. 4. The CAM circuit 33-i has address latch circuits 41, 42, a match circuit 43, and a selector circuit 44. The address latch circuit 41 receives the virtual address WVA of the address information to be written as an entry, and the write enable signal WEN-i. When the write enable signal WEN-i becomes active, the address latch circuit 41 latches the virtual address WVA being supplied, and outputs the latched virtual address WVA.

On the other hand, the address latch circuit 42 receives the physical address WPA of the address information to be written as an entry, and the write enable signal WEN-i. When the write enable signal WEN-i becomes active, the address latch circuit 42 latches the physical address WPA being supplied, and outputs the latched physical address WPA.

The match circuit 43 determines whether the virtual address of the entry already-created in the CAM circuit 33-i matches the virtual address AVA specified in the access request. The match circuit 43 receives the virtual address WVA latched by the address latch circuit 41, and the virtual address AVA specified in the access request. The match circuit 43 activates the hit signal Hit-i to be output, when the latched virtual address WVA was found to match the virtual address AVA.

The selector circuit 44 receives the physical address WPA latched by the address latch circuit 42, and the hit signal Hit-i output from the match circuit 43. When the hit signal Hit-i was found active, the selector circuit 44 outputs the latched physical address WPA as the physical address PAD-i.

As described in the above, in the CAM circuit 33-i, upon activation of the write enable signal WEN-i, the virtual address WVA and the physical address WPA of the address information are written respectively into the address latch circuits 41, 42, and stored therein. When the virtual address AVA to be input was found to match the already-created virtual address, in the process of reference to the entries, the hit signal Hit-i is made active, and the already-created physical address are output as a physical address corresponded to the virtual address AVA.

Referring now back to FIG. 3, when the new address information is stored in the CAM section 31, the write control section 32 directs writing of the address information into the CAM circuit 33-i pointed by the write pointer. The write control section 32 has write control circuits 34-i, a FIFO counter latch circuit 35, a FIFO counter increment circuit 36, an increment generation circuit 37, and a write selection circuit 38.

Each write control circuit 34-i receives the write pointer signal WPS-i, the write signal WS which requests writing of the address information, and the hit signal Hit-i output from the CAM circuit 33-i. The write control circuit 34-i controls, and then outputs, the write enable signal WEN-i and the incremental signal INC-i, in response to the received write pointer signal WPS-i, the received write signal WS, and the received hit signal Hit-i.

Upon reception of the write signal WS and the output signal from the increment generation circuit 37, The FIFO counter latch circuit 35 latches, and then outputs, an output signal of the FIFO counter increment circuit 36. The FIFO counter increment circuit 36 increments the count value output from the FIFO counter latch circuit 35 by one, and then outputs the incremented count value.

The increment generation circuit 37 directs the FIFO counter latch circuit 35 to latch the output signal of the FIFO counter increment circuit 36, based on the incremental signal INC-i output from the write control circuit 34-i. When any of the incremental signals INC-1 to INC-N is found active, the increment generation circuit 37 asks the FIFO counter latch circuit 35 to latch the output signal from the FIFO counter increment circuit 36. Accordingly, the counter value output from the FIFO counter latch circuit 35 is incremented, when the incremental signals INC-1 to INC-N become active.

The write selection circuit 38 decodes the count value output from the FIFO counter latch circuit 35, and activates any one (write pointer signal WPS-i) of the write pointer signals WPS-1 to WPS-N. The activated write pointer signal WPS-i corresponds to a write pointer which points the storage unit (CAM circuit 33-i) to be written with information next.

FIG. 5 is a drawing illustrating an exemplary configuration of each write control circuit 34-i. Each write control circuit 34-i has a write generation circuit 51, a used-bit latch circuit 52, and a used-bit circuit 53. The write generation circuit 51 receives the write pointer signal WPS-i and the write signal WS. The write generation circuit 51 activates the write enable signal WEN-i to be output, when both of the write pointer signal WPS-i and the write signal WS to be input are found active.

The used-bit latch circuit 52 is a circuit which stores that the hit signal Hit-i output from the CAM circuit 33-i was made active, or, that the address information already created as an entry in the CAM circuit 33-i has been used. The used-bit latch circuit 52 has a used-bit which indicates that the already-created address information has been used, and outputs a status of the used-bit in response to the output signal S1.

The used-bit latch circuit 52 sets the used-bit when the hit signal Hit-i is made active, or, when the address information already created in the CAM circuit 33-i was found to be used, and makes the output signal S1 active. The used-bit latch circuit 52 also clears the used-bit, when the output signal S2 (incremental signal INC-i) of the used-bit circuit 53 becomes active, and makes the output signal S1 inactive.

In other words, the used-bit latch circuit 52 sets the used-bit to activate the signal S1 when the hit signal Hit-i becomes active, and holds the status until the output signal S2 of the used-bit circuit 53 becomes active. The used-bit latch circuit 52 then clears the used-bit when the output signal S2 becomes active, and makes the output signal S1 inactive.

The used-bit circuit 53 receives the write pointer signal WPS-i, and the output signal S1 of the used-bit latch circuit 52. The used-bit circuit 53 activates the incremental signal INC-i (output signal S2) to be output, when both of the write pointer signal WPS-i and the output signal S1 of the used-bit latch circuit 52 are active. The used-bit circuit 53 is typically an AND circuit which receives the write pointer signal WPS-i, and the output signal S1 from the used-bit latch circuit 52, and outputs the incremental signal INC-i (output signal S2).

Next, operations of the micro TLB unit 21 in this embodiment will be explained.

First, operations which take place when an entry is referred to, in order to translate a virtual address specified in an access request relevant to data or the like into a physical address, will be explained.

The virtual address AVA specified in the access request is input to the individual CAM circuits 33-i, and whether the virtual address AVA matches the virtual address of the already-created entries or not is determined by the match circuit 43. If the virtual address AVA matches the virtual address of the already-created entries, the hit signal Hit-i is made active, and the already-created physical address is output as the physical address corresponded to the virtual address AVA. On the other hand, if the virtual address AVA does not match the virtual address of the entry, the hit signal Hit-i remains inactive. This action of making reference to the entries is directed to all of the CAM circuits 33-i in parallel.

Next, operations which take place when the address information is written as a new entry into the micro TLB unit 21 will be explained.

Upon reception of the write instruction of entry (the write signal WS is made active), the write control circuit 34-i activates the write enable signal WEN-i to be output to the CAM circuit 33-i pointed by the write pointer (active write pointer signal WPS-i). When the write enable signal WEN-i becomes active, the virtual address WVA is written in the address latch circuit 41, and the physical address WPA is written in the address latch circuit 42, in the pointed CAM circuit 33-i. In this way, the virtual address WVA and the physical address WPA of the address information to be newly created are stored in the CAM circuit 33-i.

Now, a control regarding the write pointer (write pointer signal) by the write control section 32 will be explained.

In parallel with the creation by writing of the new address information into the above-described CAM circuit 33-i, the FIFO counter latch circuit 35 latches pointer information (count value) which has been incremented by one, for the preparation of the next writing. In this way, the write pointer signal WPS-i, which points the CAM circuit 33-i to be written with the new entry, next to the CAM circuit 33-i previously written with the address information, is made active by the write selection circuit 38.

When the write control circuit 34-i to be input with the activated write pointer signal WPS-i has the used-bit already set therein, the write control circuit 34-i activates the incremental signal INC-i, and clears the used-bit. By activating the incremental signal INC-i of the write control circuit 34-i, a signal is output from the increment generation circuit 37, and the FIFO counter latch circuit 35 latches the pointer information (count value) which has been incremented by one. In other words, the write pointer is further incremented by one, and the write pointer signal WPS-i which points the CAM circuit 33-i in the further next position is made active by the write selection circuit 38. The write pointer is incremented by one similarly as described in the above if the used-bit is found to be set, and the process is repeated until no used-bit is found to be set. The reason why the used-bit, when found to be set, is cleared every time the write pointer is incremented by one, is to prevent the write pointer from being incremented unlimitedly.

Note that, for the case where the entry of the CAM circuit 33-i pointed by the active write pointer signal WPS-i was hit, before the new entry is written, the used-bit is set by activating the hit signal Hit-i. In response to this, the write pointer is incremented by one, and the write pointer signal WPS-i which points the CAM circuit 33-i to be written with information next is made active.

According to the first embodiment, when the entry of the CAM circuit 33-i is hit, or, when the entry of the CAM circuit 33-i was found to be used, the used-bit which indicates that the entry has been used is set to the correspondent write control circuit 34-i. On the other hand, when the used-bit corresponded to the CAM circuit 33-i pointed by the write pointer (active write pointer signal WPS-i) was found to be set (or set), the write pointer is incremented. In this way, the recently-used entry may be prevented from being rewritten (erased by overwriting), while keeping a simple control based on the FIFO scheme, without complicating the control. Accordingly, the LRU control which is directed to avoid erasure by overwriting of the recently-used entry, due to the new entry written thereon, may be implemented only with a simple configuration, and thereby the hit ratio of entry may be prevented from degrading.

### Second Embodiment

Next, a second embodiment of the present invention will be explained.

The second embodiment is similar to the first embodiment, except for the configuration of the write control circuits 34-i in the write control section 32. The description below will therefore deal with the write control circuit 34-i in the second embodiment, without repeating the explanation for the residual aspects.

FIG. 6 is a drawing illustrating an exemplary configuration of the write control circuit 34-i in the second embodiment. The write control circuit 34-i has a write generation circuit 61, and a used-bit circuit 62. The write generation circuit 61 receives the write pointer signal WPS-i and the write signal WS. The write generation circuit 61 activates the write enable signal WEN-i to be output, when both of the write pointer signal WPS-i and the write signal WS to be input are found active.

The used-bit circuit 62 receives the write pointer signal WPS-i, and the hit signal Hit-i output from the CAM circuit 33-i. The used-bit circuit 62 activates the incremental signal INC-i to be output, when both of the write pointer signal WPS-i and the hit signal Hit-i to be input are found active. The used-bit circuit 62 is typically an AND circuit which receives the write pointer signal WPS-i and the hit signal Hit-i, and outputs the incremental signal INC-i.

By configuring the write control circuit 34-i as illustrated in FIG. 6, when the entry of the CAM circuit 33-i pointed by the active write pointer signal WPS-i was hit, and the hit signal Hit-i becomes active, the incremental signal INC-i becomes active. Accordingly, the LRU control which is directed to avoid erasure by overwriting of the recently-used entry, due to the new entry written thereon, may be implemented only with a simple configuration based on the FIFO scheme, and thereby the hit ratio of entry may be prevented from degrading. Unlike the first embodiment, the second embodiment needs no latch circuit for holding the used-bit, so that the circuit area may be reduced, operations of setting and clearing the latch circuit are no longer necessary, and thereby the LRU control may be implemented by a more simple configuration.

As described in the above, in the address translation unit disclosed herein, since the pointer value is incremented when the use information of the entry pointed by the pointer value indicates that address information corresponded to the entry has been used for address translation, so that the new address information will not be written in the entry, and instead the already-stored address information will be kept. Accordingly, the LRU control which is directed to avoid erasure by overwriting of the recently-used entry, due to the new entry written thereon, may be implemented only with a simple configuration, and thereby the hit ratio in the LRU control may be prevented from degrading.

According to the embodiments, the hit ratio of entry may be prevented from degrading.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An address translation unit which translates a virtual address specified by an access request to a physical address, the address translation unit comprising:
a storage unit which includes a plurality of entries, each entry stores, in a correlated manner, address information which represents correlation between virtual address and physical address, and use information which indicates whether the address information has been used for address translation or not;
a pointer unit which holds a pointer value which points each entry into which a new address information is stored;
an increment unit which increments the pointer value held by the pointer unit;
a control unit which refers to an entry pointed by the pointer value held by the pointer unit, when the new address information is stored in the storage unit, and, when the use information of the referred entry indicates that the address information corresponded to each entry has been used for address translation, allows the increment unit to increment the pointer value, and allows storage of the new address information into an entry pointed by the incremented pointer value.

2. The address translation unit according to claim 1,
wherein, when the referred use information indicates that the address information which represents the correlation has been used for address translation, the control unit alters the referred use information so as to indicate that the address information has not been used for address translation.

3. The address translation unit according to claim 1,
wherein the control unit has a control circuit corresponded to each of the plurality of entries, and
the control circuit includes:
a write generation circuit which outputs a write signal which directs writing of the address information into the entry, when writing of the address information is requested, and when the corresponded entry is an entry pointed by the pointer value;
a latch circuit into which a status bit is set, when the use information of the corresponded entry indicates that the address information corresponded to the entry has been used for address translation; and
an output circuit which outputs an incremental signal which increments the pointer value, when the status bit is set to the latch circuit, and when the corresponded entry is an entry pointed by the pointer value,
the latch circuit clears the status bit after the incremental signal was output.

4. The address translation unit according to claim 1,
wherein the control unit has control circuits, each of which being corresponded to each of the plurality of entries, and
the control circuit includes:
a write generation circuit which outputs a write signal which directs writing of the address information into the entry, when writing of the address information is requested, and when the corresponded entry is an entry pointed by the pointer value; and
an output circuit which outputs an incremental signal which increments the pointer value, when the use information of the corresponded entry indicates that the address information corresponded to the entry has been used for address translation, and when the corresponded entry is an entry pointed by the pointer value.

5. The address translation unit according to claim 3,
wherein the entry includes:
a first latch circuit into which the virtual address contained in the address information is written and stored, in response to the write signal;
a second latch circuit into which the physical address contained in the address information is written and stored; and
a decision circuit which determines whether the virtual address specified in the access request matches the virtual address stored in the first latch circuit, and outputs the use information depending on result of decision,
the physical address stored in the second latch circuit is output, when decision circuit determines matching of the virtual address.

6. The address translation unit according to claim 1,
wherein the address information used for the address is searched in parallel over the plurality of entries.

7. A method of controlling an address translation unit which translates a virtual address contained in an access request to a physical address, in an information processing device comprising a storage unit which includes a plurality of entries, each entry stores, in a correlated manner, address information which represents correlation between virtual address and physical address, and use information which indicates whether the address information has been used for address translation or not, the method of controlling an address translation unit comprising;
referring an entry pointed by a pointer value which points an entry into which a new address information is stored, when the new address information is stored in the storage unit, by a control unit of the information processing device;
incrementing the pointer value, when the use information in the referred entry indicates that the address information stored in the referred entry has been used for address translation by a control unit of the information processing device; and
storing the new address into an entry pointed by the incremented pointer value by a control unit of the information processing device.

8. A processor comprising:
an instruction decode unit which decodes an instruction code supplied thereto;
an instruction issuing unit which issues an instruction to be executed, based on result of decoding of instruction code by the instruction decode unit;
an instruction execution unit which executes an instruction issued by the instruction issuing unit; and
an address translation unit which translates a virtual address contained in an access request received from the instruction execution unit, to a physical address,
the address translation unit including:
a storage unit which includes a plurality of entries, each entry stores, in a correlated manner, address information which represents correlation between virtual address and physical address, and use information which indicates whether the address information has been used for address translation or not;
a pointer unit which holds a pointer value which points each entry into which a new address information is stored;
an increment unit which increments the pointer value held by the pointer unit;
a control unit which refers to an entry pointed by the pointer value held by the pointer unit, when the new address information is stored in the storage unit, and, when the use information of the referred entry indicates that the address information corresponded to each entry has been used for address translation, allows the increment unit to increment the pointer value, and allows storage of the new address information into an entry pointed by the incremented pointer value.
